(19) United States
(12) Patent Application Publication
(10) Pub. No.: US 2006/0093058 A1
(43) Pub. Date: May 4, 2006

(54) Multiple list link adaptation

(75) Inventor: Dimitrios Skraparlis, Bristol (GB)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Minato-ku (JP)

(21) Appl. No.: 11/249,512

(22) Filed: Oct. 14, 2005

(30) Foreign Application Priority Data
Oct. 27, 2004 (GB) 0423866.3

(51) Int. Cl. H04L 1/02

(52) U.S. Cl. 375/267; 375/299

(57) ABSTRACT

The present invention relates to link adaptation in wireless communication, and in particular though not exclusively to wireless local area networks (WLAN). The present invention provides a link adaptation system for communication systems using multiple but separate transmission parameter options. This equates to a “double list” approach compared with the known “single list” approach. The data can be transmitted according to two or more series of predetermined transmission modes, each mode series having a common base transmission parameter such as its space time coding, and one or more rate transmission parameters such as modulation or channel coding rate. Examples of different space time coding include a more robust Alamouti ST code and a spatial multiplexing code such as BLAST. The base and rate transmission parameters can be changed independent of each other thus providing a “2D” adaptation path network of up-rating and down-rating paths. This arrangement provides great flexibility because no explicit, reliable or continuous estimation of certain channel parameters is needed (e.g. on SNR, interference, channel correlation, factors that can vary with time and is difficult to reliably estimate).

### FIELD OF THE INVENTION

The present invention relates to link adaptation in wireless communication systems, and in particular though not exclusively to wireless local area networks (WLAN).

### BACKGROUND DISCUSSION

Link-adaptation techniques are commonly used in modern wireless communications standards, such as IEEE 802.11 (WLAN). Because the channel conditions change over time due to mobility of the respective terminals, fading, interference and other well known factors, it is necessary to adapt the transmission of data in order to optimise its reception by a receiver. For example in a channel having a lot of interference and noise, the likelihood of a receiver accurately receiving signals sent at a high rate is low. Therefore it would be better to lower the transmission rate in order to increase the ability of the receiver to receive the data. The transmission rate can be varied by a number of parameters such as its coding scheme and its modulation rate.

For each adaptive wireless communication system, a list of transmission parameters (e.g. channel coding rate and constellation size) is designed and ordered in increasing data rates. Transmission parameters are dynamically changed in order to adapt to the known and unknown factors of channel quality (e.g. SNR, interference, signal power). The table below lists the modes of IEEE 802.11a.

| | Data Rate | | Coding Rate |
|---|---|---|---|
| Mode | (Mbits/s) | Modulation | (R) |
| m1 | 6 | BPSK | 1/2 |
| m2 | 9 | BPSK | 3/4 |
| m3 | 12 | QPSK | 1/2 |
| m4 | 18 | QPSK | 3/4 |
| m5 | 24 | 16-QAM | 1/2 |
| m6 | 36 | 16-QAM | 3/4 |
| m7 | 48 | 64-QAM | 2/3 |
| m8 | 54 | 64-QAM | 3/4 |

A common way to perform link adaptation for 802.11a is to use statistics on the successfully received acknowledgement (ACK) packets in order to predict the suitability of each current modulation/coding rate mode. As an example, when no acknowledgment is received, then either the current packet is retransmitted or the rate is dropped using a more robust modulation/coding rate mode. If ACK packets are received, then a less-robust higher throughput mode may be chosen.

FIG. 1 illustrates the “up-rate” and “down-rate” paths of 802.11a. Modes m1, m2 and m3 for example are the 6 Mbits/s, 9 Mbits/s and 12 Mbits/s modes respectively. As an example, on a specific instance of a 802.11a system, if the current system mode is m2 and a successful ACK (or several successful ACKs according to the specific link adaptation strategy in use) are received, then the system attempts to use the next mode, mode m3. If no ACKs are received (possibly after retransmissions) then the system drops the mode in use to mode m1.

An early example of IEEE802.11 link adaptation using ACK statistics is described in A. Kamerman and L. Monteban, “WaveLAN II: A high-performance wireless LAN for unlicensed band,” Bell Labs Technical Journal, pages 118-133, Summer 1997.

In an alternative method, the receiver measures the received packets and adjusts the transmission parameters via a feedback path to the transmitter. An example is described in “Link adaptation strategy for IEEE 802.11 WLAN via received signal strength measurement”, Pavon, Jd.P.; Sunghyun Chio, Communications, 2003. ICC '03. IEEE International Conference on, Vol. 2, Iss., 11-1.5 May 2003, Pages: 1108-1113 vol. 2. Examples of the types of parameters used include signal to noise ratio (SNR), Received Signal Strength (RSS), symbol error rate (SER), and bit error rate (BER).

Adaptive link principles have also been extended to multiple transmit and receive antenna systems such as MIMO (multiple input multiple output). Such systems are typically used to transmit parallel streams of data using spatial channels as is known. The performance of these MIMO systems is not only affected by the Signal to Noise Ratio and interference but also by the MIMO channel “condition”, which can vary over time. The MIMO channel “condition” describes how efficiently a receiver can demultiplex spatial signals that have coherently combined. Performance is degraded by:
correlation between the MIMO subchannels (e.g. through inadequate scattering)
if the channel has strong Line-Of-Sight components (i.e. large Rician K factor)
by design, having closely spaced antenna elements
even when sub-channels are uncorrelated, degenerate phenomena such as keyholes or inholes might result in a rank deficient channel transfer matrix (cause by e.g. roof edge diffractions).

Most of the above effects can vary with time, and hence in order to achieve the maximum instantaneous throughput at a desirable time, the link should be adapted according to the channel's current performance.

WO 02/091657 describes an adaptive MIMO system in which channel conditions of each sub-signal or spatial channel are measured by the receiver, and feedback to the transmitter by a feedback channel. The transmission parameters of each individual spatial channel can then be independently adjusted in order to optimise performance. For example one spatial channel can have a higher modulation and/or coding scheme (MCS) than another spatial channel.

A disadvantage with this arrangement however is the additional complexity involved which requires implementing both a feedback channel and measurements of each received spatial channel.

### SUMMARY OF THE INVENTION

In general terms the present invention provides a link adaptation system for communication systems using multiple but separate transmission parameter options. This equates to a “double list” approach compared with the known “single list” approach. Thus for example different modulation levels are provided together with different coding levels, and with predetermined up-paths or down-paths between these levels depending on transmission conditions such as reception (or not) of ACK packets following transmission.

Data is transmitted according to two or more series of predetermined transmission modes, each mode series having a common base transmission parameter such as its space time coding, and one or more rate transmission parameters such as modulation and/or channel coding rate. Examples of different space time coding include a more robust Alamouti ST code and a spatial multiplexing code such as BLAST. The base and rate transmission parameters can be changed independent of each other thus providing a “2D” adaptation network of up-rating and down-rating paths.

This “2D” approach provides greater flexibility in changing modes, for example changing space time codes independently from changing channel coding rate and modulation, instead of having joint space time code/channel coding rate/modulation configurations sorted across a “1D” list that can be crossed only up or down, thereby limiting the freedom of configuration selections. Also because channel conditions can be difficult to quantify and therefore to determine a precise mode, having one or more modes at roughly the same data rate allows these other modes (eg space time codes) to be tried independently from making a decision on increasing and/or decreasing the throughput rate through changing the modulation and/or channel coding rate which would affect the data throughput rate.

In an embodiment a transmitter transmits the data at a first base transmission parameter (eg Alamouti) and a first rate transmission parameter (eg QPSK and ¾ rate channel coding); and determines whether the data is received by the receiver. This may be achieved simply by counting ACK packets from the receiver. With sufficient ACK receipts, the link rate may be increased by increasing the base and/or rate transmission parameters, for example going to BLAST STC and/or 16QAM and ¾ channel coding rate. Alternatively if insufficient ACKs are received, the link rate can be reduced by reducing the base and/or rate transmission parameters, for example going to Alamouti STC from BLAST STC and/or 16QAM and ¾ channel coding rate to 16QAM and ½ channel coding rate.

The arrangement is particularly well suited to MIMO types systems in which the base transmission parameters are different space time code (STC) options. Thus a more robust STC such as the Alamouti code is selected when a most robust transmission is required, and an STC which allows for greater spatial multiplexing such as BLAST is used when the channel is more favourable towards high data rates.

The arrangement can be implemented in various wireless communication systems such as Wireless Local Area Networks (WLAN) such as IEEE802.11, metro LANs such as the new IEEE802.16 standards, or cellular networks such as GPRS and UMTS.

In particular in one aspect the present invention provides a method of wireless link adaptation according to claim 1.

In particular in another aspect the present invention provides a transmitter for wireless link adaptation according to claim 13.

There is also provided a method of transmitting wireless data according to the method of claim 1; and a method of receiving data corresponding to claim 1. More specifically there is provided a method of receiving wireless data, the receiver arranged to receive data according to two or more series of predetermined reception modes, each mode series having a number of reception modes each having a common base reception parameter and said number of rate reception parameters; the method comprising: receiving the data at a first base reception parameter and a first rate reception parameter; receiving the data at a second base reception parameter; receiving the data at a second rate reception parameter. Preferably the base reception parameter is a space time code; for example Alamouti and BLAST.

A corresponding receiving apparatus is also provided. As is a corresponding communications system comprising such as transmitter and receiver; and which is preferably a MIMO system.

### BRIEF DESCRIPTION OF THE DRAWINGS

Embodiments will now be described with respect to the following drawings, by way of example only and without intending to be limiting, in which:

FIG. 1 is a known link adaptation scheme for an IEEE802.11 WLAN;

FIG. 2 is a schematic of a MIMO system;

FIG. 3 is a schematic of a link adaptation apparatus according to an embodiment;

FIG. 4 is a flow chart illustrating the operation of the apparatus of FIG. 3;

FIG. 5 illustrates the “double list” scheme of FIG. 4;

FIGS. 6a and 6b show respectively the throughput v SNR characteristics of the Alamouti and BLAST space time codes for different scattering angles;

FIG. 7 is a flow chart of an alternative double list scheme; and

FIG. 8 illustrates the “double list” scheme of FIG. 7.

### DETAILED DESCRIPTION

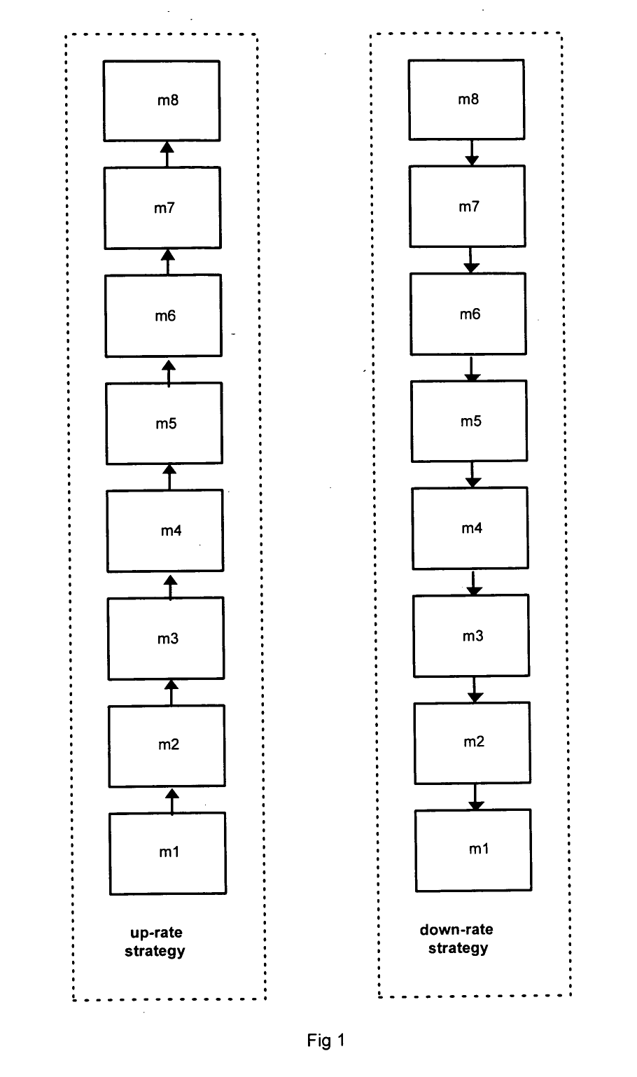

As described above with respect to FIG. 1, predetermined levels or modes of throughput, data rate or performance are assigned in a link adaptation system, and the system moves up and down these levels in a linear fashion dependent on current link conditions such as SNR. Each level is typically associated with a particular combination of modulation and channel coding rate or a predetermined modulation and coding scheme (MCS). A higher level can have a higher modulation rate, for example QPSK compared with BPSK, and/or a higher channel coding rate, for example ⅔ compared with ½.

However such arrangements are limited in cases where the channel condition or quality are constantly changing or when it is difficult to reliably estimate them, for example in indoor WLAN type environments. This problem is exacerbated in transmit diversity or spatial multiplexing systems such as MIMO, in which a greater number of factors (that cannot always be reliable estimated) affect the performance of the system.

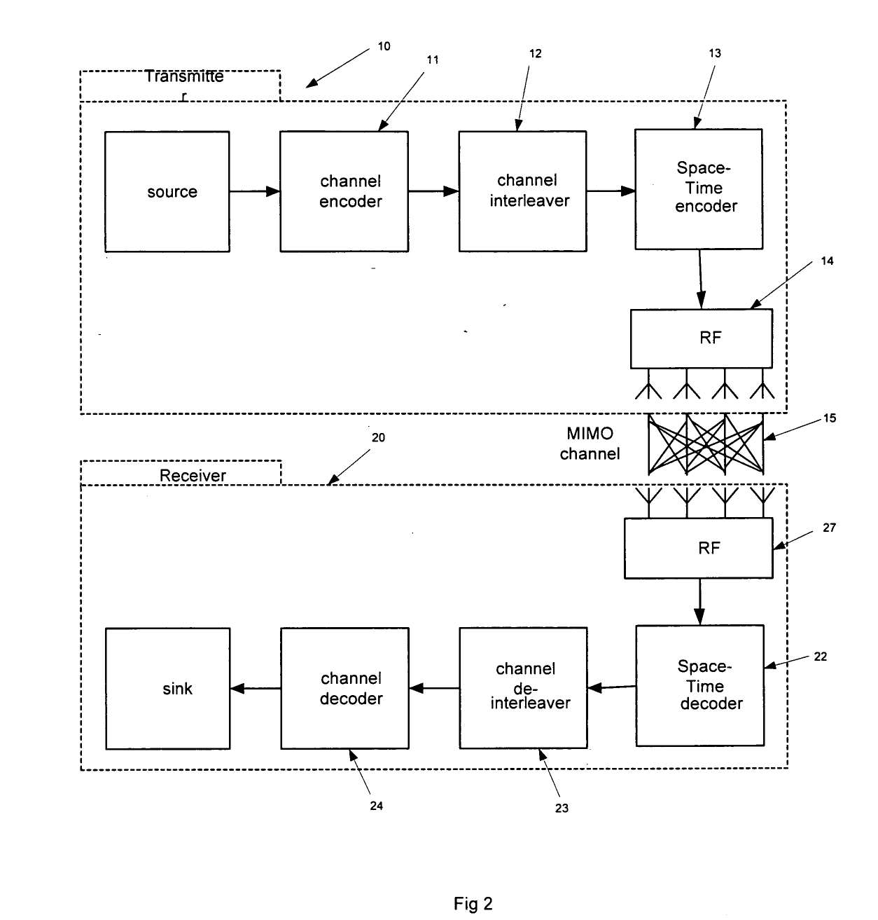

FIG. 2 shows a schematic of a MIMO communications system. Data to be transmitted is encoded by a channel encoder 11 at a particular code rate and interleaved by a channel interleaver 12. The channel processed data is then passed to a space time encoder 13 which splits the data into parallel paths and processes them separately using a Space-Time code such as Alamouti for example. The parallel data streams are then processed in an RF module 14, for example modulating the data on to a particular constellation. The modulated data is then fed to separate antennas on the transmitter 10. As is known, the signals are transmitted into a MIMO channel 15 to be received by the multiple antennas of a receiver 20. The received signals are converted to baseband by the RF receiving module 21 which demodulates the received signals. These baseband signals are then fed to a space time decoder 22 which recovers the parallel data streams and combines them, before feeding them to a de-interleaver 23 which corresponds to the interleaver 12. The de-interleaved data is then processed by a channel decoder 24 using the same coding scheme and rate as the coder 11 in the transmitter 10. The recovered data is then further processed as is known.

The channel encoding scheme and rate used by the encoder 11 and decoder 24, as well as the modulation scheme used by the transmit RF block 14 and the receive transmit block 21 can be predetermined in advance. Where link adaptation is required, some mechanism for coordinating these parameters between the transmitter 10 and the receiver 20 is needed. At its simplest, this may require an ACK packet from the receiver every time it successfully receives a frame or series of packets of data from the transmitter 10. The receipt or absence of these ACK packets informs the transmitter 10 on whether the data is being successfully received. A more sophisticated approach is to have an independent feedback channel whereby the receiver informs the transmitter about its current reception success. It may also feedback information on the current status of the MIMO channel 15.

In this way the link can be adapted to the MIMO channel conditions, for example increasing the modulation and/or coding rate when the link is more robust as evidenced by a succession of received ACK packets for example.

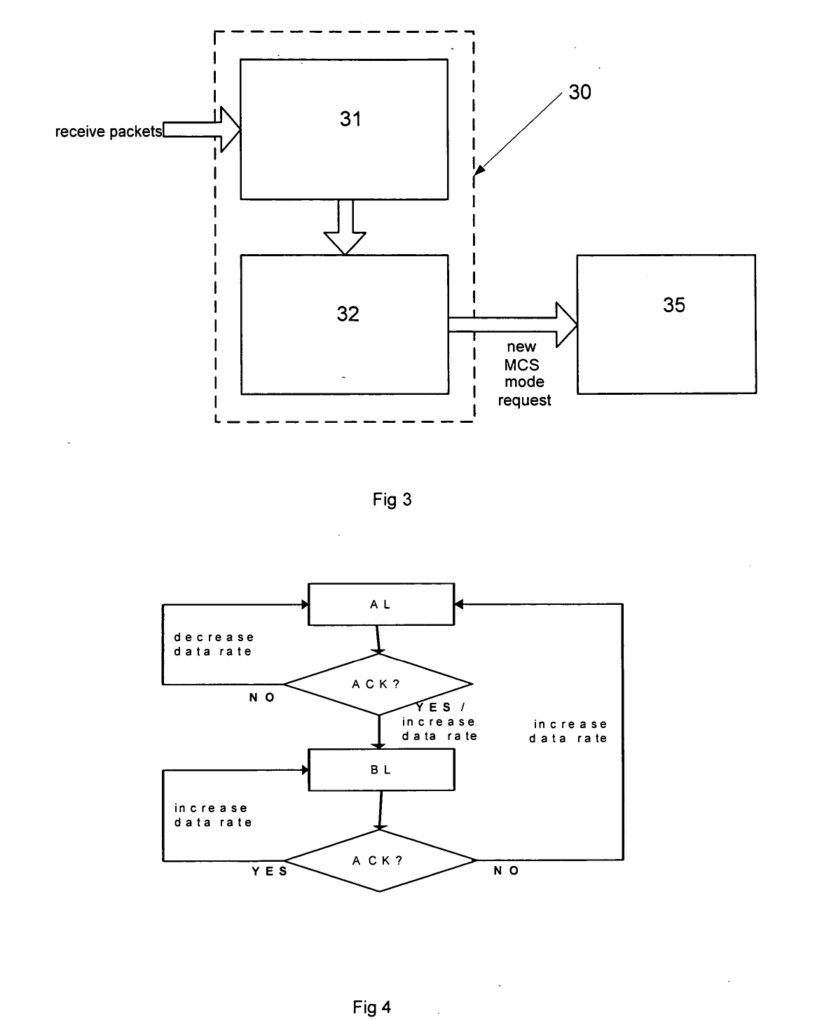

A method of operating the MIMO system of FIG. 2 according to an embodiment is described with respect to FIGS. 3, 4, and 5.

FIG. 3 illustrates a mode selection apparatus 30 in the transmitter 10. The mode selection apparatus 30 may be implemented in software and comprises a link reliability estimator 31, and a mode selector 32. The mode selector 32 instructs a link adaptation controller 35 which forms part of a standard link adaptation enabled transmitter 10. The estimator 31 determines whether the receiver 20 is successfully receiving data sent by the transmitter 10. Received packets information is used in the link reliability estimator 31 in order to decide if the current constellation/coding rate/space-time code mode is appropriate for the current channel conditions. The link reliability estimator 31 is preferably simply an ACK counter, although more sophisticated received packets statistics could also be used. The output of this functional block 31 can either be a simple indication as to whether this mode is reliable or not. It is also possible to output an indication of “how good” this mode is.

The information from the link reliability estimator 31 is then passed to the mode selector 32. The mode selector 32 attempts to estimate the best mode for the current channel conditions, given the information provided by the link reliability estimator 31. It then requests the mode from the link adaptation control resource 35, which will issue a mode change control packet that requests a mode change to the mode number from the table of transmission modes which is common for all devices.

In the embodiment, use is made of different space time codes (STC) as well as other transmission parameters such as modulation and channel coding rates. For example, space time (ST) multiplexing such as provided by BLAST can be chosen when the channel has good condition (low correlated spatial substreams) and the Alamouti ST-code can be chosen when the channel quality is poor.

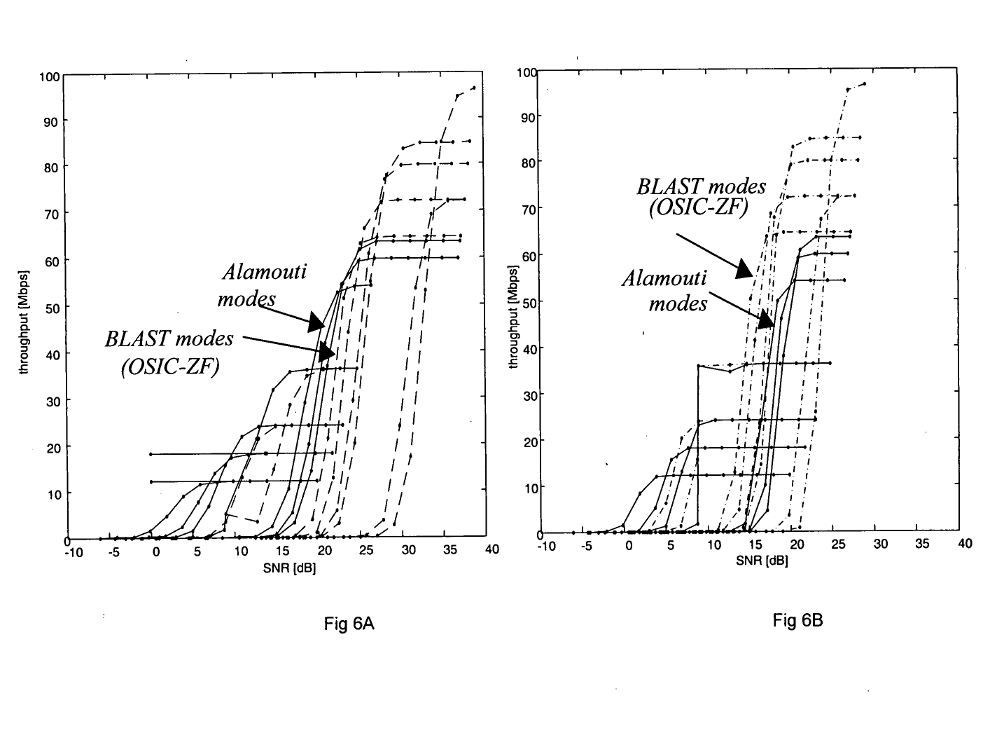

The performance of ST-multiplexing modes surpasses the performance of Alamouti ST-codes for the same throughput modes when the sub-channels are highly uncorrelated. The opposite effect is observed with highly correlated (“bad quality”) channels, because Alamouti and other ST-codes are more robust to poor quality MIMO channels. This is illustrated in FIGS. 6a and 6b. Whether BLAST or the Alamouti ST-code delivers more throughput depends on the angular spread; FIG. 6a shows data throughput v SNR for a spread of 30 degrees, and FIG. 6b for uncorrelated spatial channels.

A double link adaptation list is used which utilises two (or more) STCs. One list (BLAST STC) is targeted at “good quality” channel instances and the other list (Alamouti STC) is for “bad quality” channel instances. The system can move between the lists (Alamouti and Blast) as well as within these lists. The common transmission parameter of each list (in this case the STC) is here termed the base transmission parameter. The transmission parameter or combination of parameters (here modulation and channel coding rate) is here termed the rate transmission parameter. The double list therefore presents a 2D network of possible up-rating and down-rating. This arrangement provides great flexibility because no explicit, reliable or continuous estimation of certain channel parameters is needed (e.g. on SNR, interference, channel correlation, and other factors that can vary with time or are unknown). Thus for example if insufficient ACK packets are received, rather than lower throughput by reducing the channel coding and/or modulation rate, a different space time code can be used which might maintain (or increase) the current throughput in the current channel conditions (whatever they are).

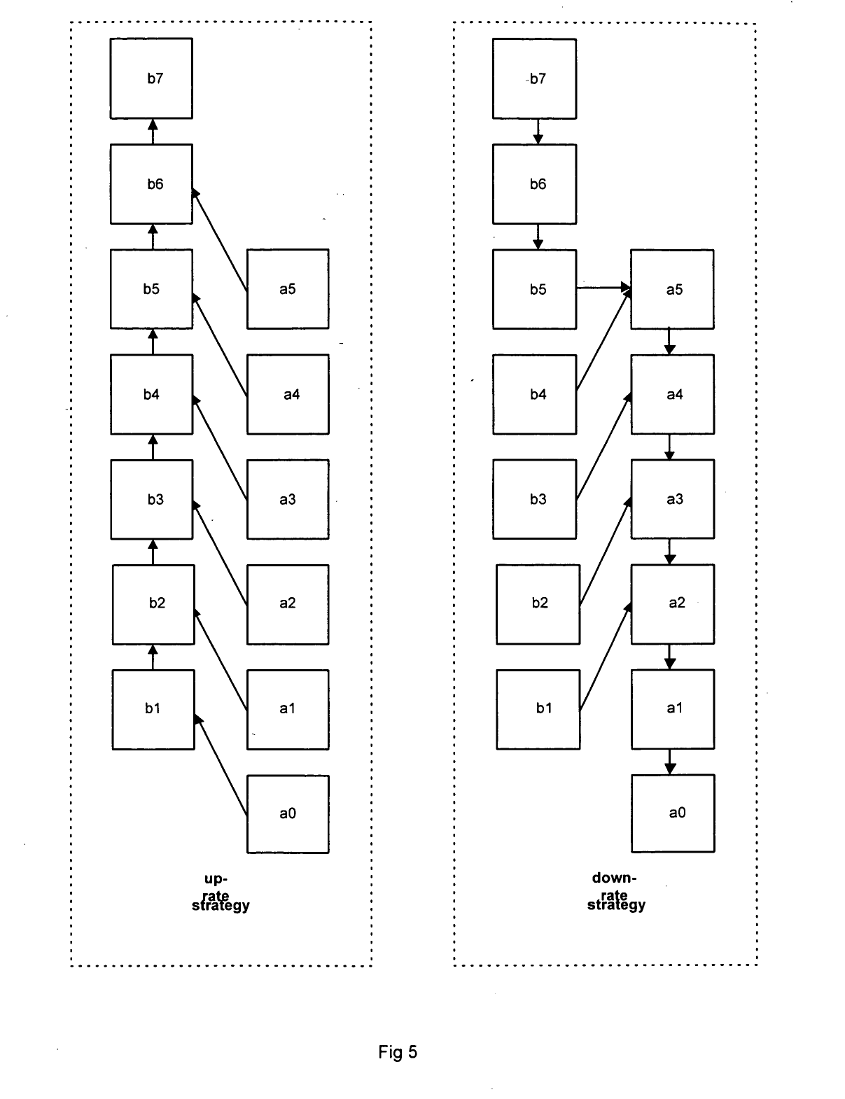

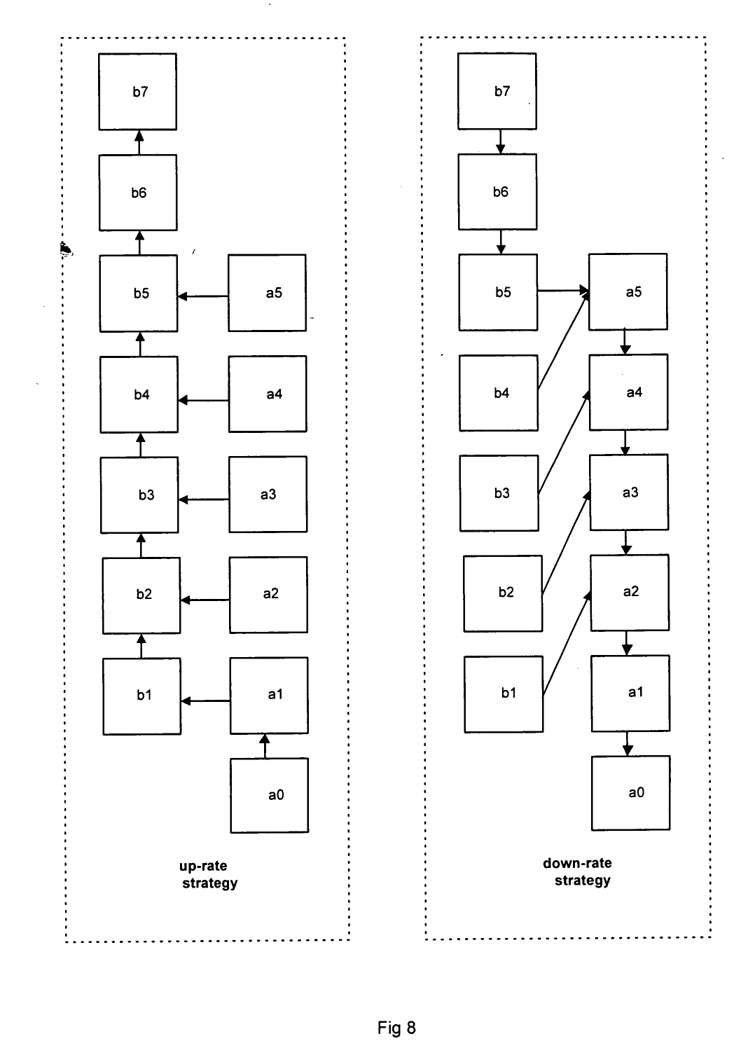

Up-rating and down-rating paths or protocols which are dependent on current channel conditions, or at least indications of sufficient or insufficient reception success (via ACK count), can be pre-determined in advance. Two examples are given in FIGS. 5 and 8.

In a first embodiment, switching between STCs in the mode selector 32 is performed according to the flow diagram of FIG. 4. Thus for example if the current mode is one employing Alamouti (AL) ST-coding and there are no successful ACKs, a lower throughput mode (for example lower modulation and/or channel coding rate) using the same ST-code is chosen. If successful ACKs are received, then the system attempts to use ST-multiplexing (for example by implementing BLAST instead of Alamouti). If the current mode is a ST-multiplexing mode and successful ACKs are received, then the system insists on ST-multiplexing, and increases the data rate, for example by increasing the modulation and/or channel coding rate. If no ACKs are received, the system makes an attempt on choosing Alamouti ST-coding while increasing the data rate (ie higher modulation and/or coding rate then used with ST multiplexing/BLAST). This is an aggressive strategy that attempts to deliver as high throughput as possible. It is of course possible to alter the strategy to more conservative ones, for example keeping the same modulation and channel coding rate but changing the ST coding.

FIG. 5 illustrates the “double-list” link adaptation strategy according to the flow diagram of FIG. 4, for a system employing an MCS list of 7 ST-multiplexing modes (modes b1 to b7) and 6 ST-encoded modes (modes a0 to a5). Modes b and a with the same index have the same nominal throughputs by choosing appropriate modulation/coding rate configurations (e.g. modes b1 is a BPSK, ½ coderate BLAST mode and a1 is a QPSK ½ coderate Alamouti mode—both are 12 Mbits/s modes). However modes in a different series (a or b) but having the same index (1-5) need not have the same nominal throughputs.

Whenever the current mode is a more robust Alamouti mode (a0-a5), and ACK packets are being successfully received, or some other suitable measure is determined, the mode selector 32 adjusts the transmission parameters of the transmitter 10 to switch to BLAST STC processing, and additionally to increment the data rate (modulation and/or coding rate). Thus for example the link may go from the lowest mode a0 using the lowest modulation and coding rate as well as Alamouti ST-coding, to a higher modulation and coding rate as well as BLAST ST-coding (b1).

By contrast when a “down-rate” is required, when the link is below a set data rate (5), it tries to lock onto the more robust Alamouti ST-coding, for example going from b5 to a5. Above this set rate, the link moves linearly up and down the BLAST modes b5 to b7. In a further alternative, when down-rating for example, jumps of two or more modes might be implemented, for example b7 to b5. For BLAST rates below 5, when down-rating, the link moves to the more robust Alamouti ST-coding, but also to a higher data rate; for example from b3 to a4. Thus the link attempts to maintain the data rate but using a different transmission strategy which may be more suitable for current MIMO channel conditions.

It can be observed that there are no deadlocks in the combined uprate/downrate strategy (all modes have an up-rate and a down-rate path). In the up-rate strategy, it tries to “lock” on the ST-multiplexing modes, which have the potential of higher achievable throughputs under favourable conditions. In the down-rate strategy, it tries to “lock” on the robust Alamouti ST-code instead.

By modifying the specific up-rate and down-rate strategies (the up-rate and down-rate paths of FIG. 5), it is possible to alter the convergence speed of link adaptation and optimize the double-list for specific applications. Further embodiments using different up-rate and down-rate schemes are described below.

The receiver adapts the transmission parameters by using control packets (that contain control information) as is known. By using control packets, two devices can agree on new transmission parameters (coding rate, modulation, space-time code) by simply agreeing on a mode number.

The embodiment allows a communication system with limited knowledge of the factors that affect performance to adapt its transmission parameters (using multiple lists) without attempting to estimate every one of the factors. A particular example was given of a system doing link adaptation of modulation (e.g. BPSK, QPSK, 16-QAM, 64-QAM), coding rate (e.g. ½, ⅔, ¾) and Space-Time codes (e.g. Alamouti, ST-multiplexing) at MIMO channels whose properties (e.g. SNR, interference, channel correlation) vary with time or are unknown. Without having the need for a MIMO channel quality estimator (e.g. estimation of channel condition), the system is able to do link adaptation based on counting received ACK packets by using only a simple-double list strategy to switch between Space-Time codes and modulation/coding rates.

The described embodiment utilizes either binary (presence of Acknowledgment—ACK packets) or very limited feedback. This is preferred because it is difficult to design a reliable channel quality estimator. In addition, any explicit feedback of the channel quality would degrade the overall system throughput (because more control bits rather than information bits are transmitted), so the embodiment avoids that overhead by keeping the simple feedback mechanism. By using only the information gathered by the presence of ACK packets, compatibility with existing chip firmware and medium-access control (MAC) mechanisms is preserved; for example with existing IEEE802.11 or HiperLAN equipment.

However any amount of feedback could be used, including systems that use feedback on the MIMO channel “quality” or Quality Of Service. It is also possible that a system that utilizes more feedback (exchanges more information between the transmitter and receiver than just an Acknowledgment—binary feedback) would follow more than one step at a time on the double list paths (thus adapting faster). For example by going from a2 to b4, or from b5 to a3 for large changes in MIMO channel conditions as might be consistent with a mobile terminal in an indoor WLAN moving out of or into an RF shadow.

Whilst the embodiment utilises a “double list” strategy where each list has a different STC, other transmission parameters could alternatively be assigned to the different lists. For example modulation rate may be assigned to one (the base transmission parameter), and channel coding rate to the other (the rate transmission parameter). Thus embodiments could be implemented in non-MIMO based systems, for example those utilising simple SISO channels. Such a strategy still assists with link adaptation where there are factors affecting channel conditions that is difficult to reliably quantify. Another example combination of parameters is to use different antenna directivity configurations as a base parameter and different modulation/channel coding rate combinations as the rate transmission parameters.

Also, it should be noted that it is also possible to devise a triple list (or lists with more branches, or even multi-dimensional lists) in the case that more than two ST-codes are employed; or other parameter(s) instead of ST-codes.

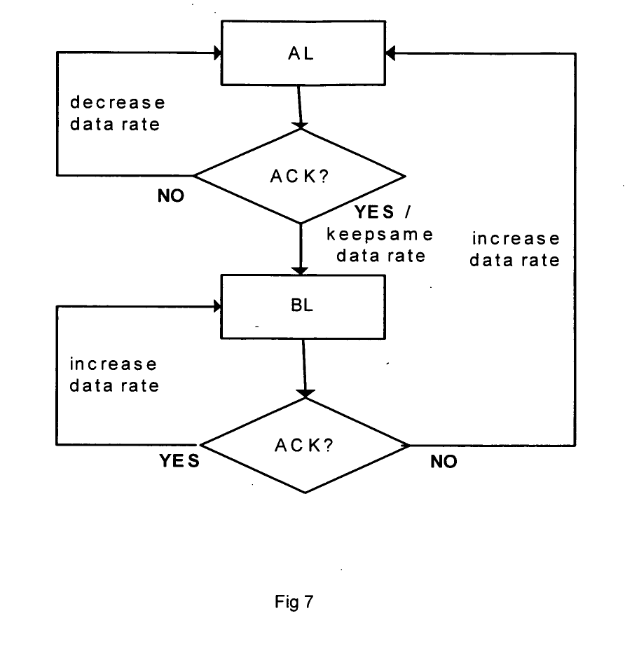

A second embodiment is illustrated with respect to FIGS. 7 and 8. Compared with the first embodiment, when moving from Alamouti to Blast modes, the same data rate is kept instead of trying to increase it.

More specifically, the same double list structure is used as shown in FIG. 8, one list associated with a robust STC a0-a5 (eg Alamouti) and one list associated with a higher data rate or throughput STC b1-b7 (eg BLAST). As illustrated in FIG. 7, this is also still implemented by a double loop process. If ACKs are received on the Alamouti STC (a0-a5), then the system attempts to adapt the link to the Blast STC (b1-b7), keeping the same data rate. As can be seen from the graphs of FIG. 6, the less robust modes (e.g. BL) can outperform the more robust ones (e.g. AL) under favourable channel conditions. The up-rate strategy described here is to move from AL to BL hoping that the channel condition favours BL. In case it doesn't, it is more “safe” to move to an equal data rate mode than moving to a higher rate mode (as in FIG. 5) because the risk of dropping the delivered throughput due to inappropriate choice of modes is smaller (the experienced throughput will drop more if the chosen mode is “far” from the optimal/appropriate mode in the double list structure). Then if the channel conditions change such that ACK packets are no longer received, or not received in sufficient numbers, then the system falls back to the more robust STC. This allows the system to adapt to changes in channel conditions without having to estimate the channel quality.

The skilled person will recognise that the above-described apparatus and methods may be embodied as processor control code, for example on a carrier medium such as a disk, CD- or DVD-ROM, programmed memory such as read only memory (Firmware), or on a data carrier such as an optical or electrical signal carrier. For many applications embodiments of the invention will be implemented on a DSP (Digital Signal Processor), ASIC (Application Specific Integrated Circuit) or FPGA (Field Programmable Gate Array). Thus the code may comprise conventional programme code or microcode or, for example code for setting up or controlling an ASIC or FPGA. The code may also comprise code for dynamically configuring re-configurable apparatus such as re-programmable logic gate arrays. Similarly the code may comprise code for a hardware description language such as Verilog™ or VHDL (Very high speed integrated circuit Hardware Description Language). As the skilled person will appreciate, the code may be distributed between a plurality of coupled components in communication with one another. Where appropriate, the embodiments may also be implemented using code running on a field-(re)programmable analogue array or similar device in order to configure analogue hardware.

The skilled person will also appreciate that the various embodiments and specific features described with respect to them could be freely combined with the other embodiments or their specifically described features in general accordance with the above teaching. The skilled person will also recognise that various alterations and modifications can be made to specific examples described without departing from the scope of the appended claims.

1. A method of link adaptation for a wireless transmitter in order to communicate optimally with a wireless receiver, the transmitter arranged to transmit data according to two or more series of predetermined transmission modes, each mode series having a number of transmission modes each having a common base transmission parameter and said number of rate transmission parameters; the method comprising:
transmitting the data at a first base transmission parameter and a first rate transmission parameter;
transmitting the data at a second base transmission parameter;
transmitting the data at a second rate transmission parameter.

2. A method according to claim 1 wherein the transmitter and receiver each comprises multiple antennas in order to form a MIMO system.

3. A method according to claim 2 wherein the base transmission parameter is a space time code.

4. A method according to claim 3 wherein one of the space time codes is Alamouti and the other is BLAST.

5. A method according to claim 1 wherein the rate transmission parameter is one or a combination of the following: modulation rate; channel coding rate.

6. A method according to claim 1 and having an up-rate protocol comprising:
adapting from a lower base transmission parameter to a higher base transmission parameter; and
adapting from said higher base transmission parameter to a higher rate transmission parameter.

7. A method according to claim 6 wherein said adaptation from the lower base transmission parameter to the higher base transmission parameter further comprises maintaining the same rate transmission parameter.

8. A method according to claim 6 wherein said adaptation from the lower base transmission parameter to the higher base transmission parameter further comprises adapting to a higher rate transmission parameter.

9. A method according to claim 1 and having a down-rate protocol comprising:
adapting from a higher base transmission parameter to a lower base transmission parameter; and
adapting from said lower base transmission parameter to lower rate transmission parameter.

10. A method according to claim 9 wherein said adaptation from the higher base transmission parameter to the lower base transmission parameter further comprises maintaining the same rate transmission parameter.

11. A method according to claim 9 wherein said adaptation from the higher base transmission parameter to the lower base transmission parameter further comprises adapting to a higher rate transmission parameter.

12. A carrier medium carrying processor code arranged when executed on a processor to carry out the method according to claim 1.

13. A wireless transmitter for communicating data to a wireless receiver, the transmitter comprising:
transmitting means operable to transmit the data according to two or more series of predetermined transmission modes, each mode series having a common base transmission parameter and one or more rate transmission parameters; the method comprising:
transmitting means operable to transmit the data at a first base transmission parameter and a first rate transmission parameter;
transmitting means operable to transmit the data at a second base transmission parameter;
transmitting means operable to transmit the data at a second rate transmission parameter.

14. A transmitter according to claim 13 wherein the transmitter comprises multiple antennas in order to form a MIMO system with the receiver.

15. A transmitter according to claim 14 wherein the base transmission parameter is a space time code.

16. A transmitter according to claim 13 wherein the rate transmission parameter is one or a combination of the following: modulation rate; channel coding rate.

17. A transmitter according to claim 13 and having means for implementing an up-rate protocol which comprises:
first base transmission parameter adapting means for adapting from a lower base transmission parameter to a higher base transmission parameter; and
second base transmission parameter means for adapting from said higher base transmission parameter to a higher rate transmission parameter.

18. A transmitter according to claim 17 wherein said first base transmission parameter adapting means further comprises parameter maintaining means operable to maintain the same rate transmission parameter.

19. A transmitter according to claim 17 wherein said first base transmission parameter adapting means further comprises third base transmission parameter adapting means for adapting to a higher rate transmission parameter.

20. A transmitter according to claim 13 and having protocol implementing means for implementing a down-rate protocol which comprises:
first base transmission parameter adapting means for adapting from a higher base transmission parameter to a lower base transmission parameter; and
second base transmission parameter means for adapting from said lower base transmission parameter to lower rate transmission parameter.

21. A transmitter according to claim 20 wherein said first base transmission parameter adapting means further comprises maintaining means for maintaining the same rate transmission parameter.

22. A transmitter according to claim 20 wherein said second base transmission parameter adapting means further comprises third parameter adapting means for adapting to a higher rate transmission parameter.
